(19) United States
(12) Patent Application Publication
(10) Pub. No.: US 2008/0065680 A1
(43) Pub. Date: Mar. 13, 2008

(54) CHANGE AND RELEASE MANAGEMENT SYSTEM

(75) Inventors: Carroll W. Moon, Matthews, NC (US); Neal R. Myerson, Seattle, WA (US); Susan Pallini, Windham, NH (US); Gary J. Baxter, Redmond, WA (US); Thomas D. Applegate, North Bend, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/531,247

(22) Filed: Sep. 12, 2006

(51) Int. Cl. G06F 7/00

(52) U.S. Cl. 707/102

(57) ABSTRACT

A change and release management process tool allows storing change and release records in a common record schema. A database may be used to store change and release records. The tool provides a unified tracking and reporting system. Reports are provided at various aspects of the process. The technology facilitates best practices in change and release management.

### BACKGROUND

There is more pressure than ever on companies to employ a well structured management process to deploy changes in the company's information technology (IT) environment. Changes include items like bug fixes, software upgrades, performance improvements, and hardware upgrades. This pressure is due to many factors, including the need of maintaining accurate records to prove data accuracy in financial reporting to outside auditors. IT organizations generally plan changes to their systems and implement them in some form of orderly process. Changes are developed, tested, and packaged into releases for deployment. The change and release management process of the IT organization is responsible for introducing these changes and managing their release.

The goal of a change and release management process is to ensure all changes are deployed successfully into the production IT environment in the least disruptive manner. The IT Infrastructure Library (ITIL®) provides widely accepted best practices for IT service management practices for use by IT organizations.

A change and release management process includes determining the readiness of each release based on release criteria, including, for example, the quality of the release, release package and production environment readiness, training and support plans, rollout and backout plans, testing, and risk management plans. After planning and configuring a change, the change and release management process may include a change review to ensure that the release was successful.

A number of software tools have been developed in order to make change and release management easier on IT organizations. However, many companies implement the processes and the tools without adequate focus on the reason they are implementing the process or the tool. This is primarily due to the fact none of the tools or processes alone adequately address the distributed computing space that makes up most of the IT management landscape.

Existing tools and processes do not easily facilitate data and metric gathering about the performance of the processes themselves because the tools are instrumented without the proper, meaningful categories. Thus, the data that comes from these tools is inadequate.

### SUMMARY

Technology is disclosed herein for implementing a change and release management process by storing change and release records in a common record schema. In one embodiment, a database is used to store change and release records. The technology facilitates best practices in change and release management.

Changes to a computing environment are managed by organizing the environment into a logical representation characterized by groups of elements sharing at least one common characteristic. Changes to the environment are recorded changes to elements in the computing environment in terms of a change to at least one group of elements and the changes are stored in a common record format including an association of the change with other groups of elements affected by the change. By using a common record format, changes and releases are stored in a single record, for a group of elements in the infrastructure. The technology then facilitates the change management process through the steps of evaluating a request for change, testing the request, approving and scheduling the change for release, implementing the change, evaluating the release following implementation, and closing the change request.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a flow chart showing a first method for implementing a change and release process in accordance with the technology discussed herein.

FIG. 2 depicts a flow chart illustrating a process of recording a change request in accordance with the technology disclosed herein.

FIG. 3 depicts a flow chart illustrating a process of recording a release in accordance with the technology disclosed herein.

FIG. 4A is a block diagram depicting the interaction between a system implementing the technology and a change and release process.

FIG. 4B is a block diagram of an exemplary computing environment disclosed in FIG. 4A.

FIG. 5 depicts a user interface input form in accordance with the technology disclosed herein.

FIG. 6 depicts a first user interface view in accordance with the technology disclosed herein.

FIG. 7 depicts a second user interface view in accordance with the technology disclosed herein

FIG. 8 depicts a downtime report table included in the reporting options of the technology disclosed herein.

FIG. 9 depicts a graph of planned and unplanned trends which may be provided by the reporting features of the present technology.

FIG. 10 depicts an analysis report table which may be provided by the reporting features of the present technology.

FIGS. 11-19 depict analysis graphs which may be provided by the reporting features of the present technology.

### DETAILED DESCRIPTION

Technology is disclosed herein for implementing a change and release management process by storing change and release records in a common record schema. The technology provides a tool for IT service managers to facilitate change and release management using a unified tracking and reporting system. In one embodiment, a defined taxonomy of the IT organization may be used with the unified tracking and reporting system to drive change and release management processes. Reports are provided at various aspects of the process. In a second embodiment, a database is used to store change and release records.

The impetus for change management is to reduce risk by managing change better, reduce the amount of change and reduce the cost of managing change. Change management seeks to be proactive and predictable while reducing costs. The technology facilitates best practices in change and release management.

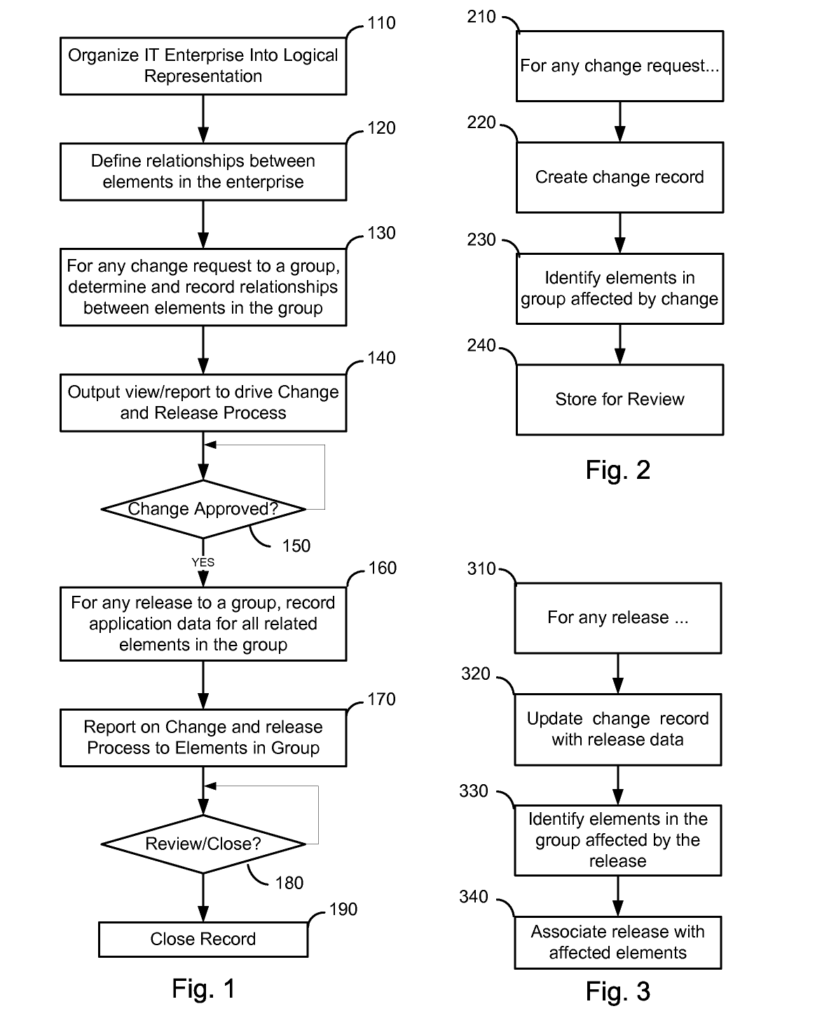

FIGS. 1 through 4 illustrate a method in accordance with the technology disclosed herein for implementing a change and release management process in an IT enterprise. In general, an IT enterprise may consist of one or more distributed computing devices connected to one or more public and private networks. The IT environment of the enterprise includes multiple information technology services provided on one or more hardware systems. The hardware systems may be distributed and networked. Services provided in the environment include, for example, file transfer systems, electronic mail systems, back-up systems, firewalls, databases, and the like. Services on the system can connect to interoperate with, and/or rely on many other services. The Change and release management system covers all situations where one needs to update, change, modify or otherwise service any of the computing devices in the enterprise.

FIG. 1 illustrates a general method for implementing a change and release management process. At step 110, the IT enterprise is organized into logical categories. In one embodiment, this may include defining any number of categories, groups, or commonalities amongst hardware, applications and services within the organization. The grouping may be performed in any manner. One example of such a grouping is disclosed in U.S. patent application Ser. No. 11/343,980 entitled “Creating and Using Applicable Information Technology Service Maps,” Inventors Carroll W. Moon, Neil R. Myerson and Susan K. Pallini filed Jan. 31, 2006, assigned to the assignee of the instant application and fully incorporated herein by reference. In the service map categorization, common elements among various distributed systems within an organization are determined and used to track changes and releases based on the common elements, rather than, for example, physical systems individually. In the aforementioned application Ser. No. 11/343,980, a service map defines a taxonomy of level of detail of competing components in the information technology infrastructure is defined. The technology service method used to simplify information technology infrastructure management. The service map maps a corresponding information technology infrastructure with a specified level of detail and represents dependencies between services and streams included in the technology service map. Although the service map of application Ser. No. 11/343,980 is one method of organizing an IT infrastructure, other categorical relationships may be utilized.

At step 120, relationships between elements in the taxonomy are defined. Step 120 defines the relationships between the various elements in taxonomy so the changes to one or more categories or reflected in other category or elements residing in sub categories. For example, one might define a common group comprising services, and a group of services comprising messaging. Another group may be defined by exchange mail servers, and still other groups defined by the particular types of hardware configurations within the enterprise. At step 120, one can define the relationships between the mail servers are a subcategory of the messaging service, and define which hardware configurations are associated with exchange servers.

In accordance with the technology discussed herein, changes are defined and releases are applied to one of the groups within the taxonomy, rather than to individual machines or elements within the taxonomy. Hence, a change to upgrade all email servers is defined for the group, and all other groups which are affected are then known by reference to the relationships defined in step 120. Similarly, if one were to define a category of a hardware model of a particular server type, changes to that particular hardware model might affect one or more categories of applications or services provided by the hardware model.

Thus, while in some current change management tools one might log a change for all 1,000 servers in an enterprise, in the present technology, all 1,000 servers (or subsets thereof) might be grouped together based on a common characteristic, and one change is logged for all servers having that particular characteristic.

In accordance with the foregoing, any change required for the enterprise is defined first in terms of a request, and submitted as a change to at least one group defined in step 120. As such, at step 130, for any change request to a group, the relationships between the groups are determined and recorded as part of the change record. In this manner, a change request is applied to a group which may effect one or more servers, services, applications and/or other groups. As discussed below, this request is stored in a common schema or change record which tracks the request through the request, testing, approval, release and review stages of a change and release management process. The record of the change request ultimately serves as the record of the release effect. The change request is the first stage of a change and is generally initiated by an IT administrator. The change request may alternatively referred to herein as a “request for change” or “RFC.”

FIG. 2 illustrates a method for entering a change request in accordance with step 130. At step 210, for any change request, the method requires entry of a set of required data at step 220. As noted above, a common schema for a change and release record is utilized in the technology and in one embodiment, the required data is a subset of the data defined below in Table 1. At step 230, the change data entered at step 220 forms a change request record and is recorded in a database. At step 240, once saved, the request is ready for process review by a change management team.

At step 140, the change request input at step 130 may be output to a user interface view or to a report in order to drive a change and release management process. Operations in the change and release management process may include evaluating the request, testing the request, approving the change for release, implementing the change, evaluating the release following implementation, (step 180) and closing the change request (step 190). The change and release management process may be specific to the individual organization, and any number of different change or management processes may be used in accordance with the present invention. A number of best practices are, as set forth above, defined by ITIL, but any change and release management process may be utilized in accordance with the present technology.

During the change and release management process, the change will be approved or disapproved at step 150. If the change is approved, implementation of the change results in a release to the group defined in step 120. At step 160, information regarding the effect of the release is recorded to all related elements in the group at step 160. This allows reporting and tracking of the effects of a release at step 170.

FIG. 3 represents the manner in which a change record is updated and data regarding the release is distributed to affected elements in the IT Enterprise. For any release at step 310, release data is entered into the change record at step 320. At step 330, data regarding the release is associated with all elements in the infrastructure affected by the release. At step 340, data regarding the release is stored in association with the affected elements in the taxonomy for use in the review steps 170, 180 and 190. In one embodiment, all data in the change record is entered manually. In another embodiment, the changes are dynamically linked so that a change to one service affects and acknowledges the change amongst any server connected with that particular bucket. In a further embodiment, a table of automatically generated outage records, for example from a Microsoft Management Operations Manager database, may be used to link each actual outage back to the change record entered. Thus, the change record has 100% accurate outage duration, discreet change count, and the like.

As noted above, following the release, the technology includes a reporting capability. At step 170, one or more reports may be generated and used in a review process 180. The review process is used to make future releases more efficient. Finally, the change record may be closed at step 190.

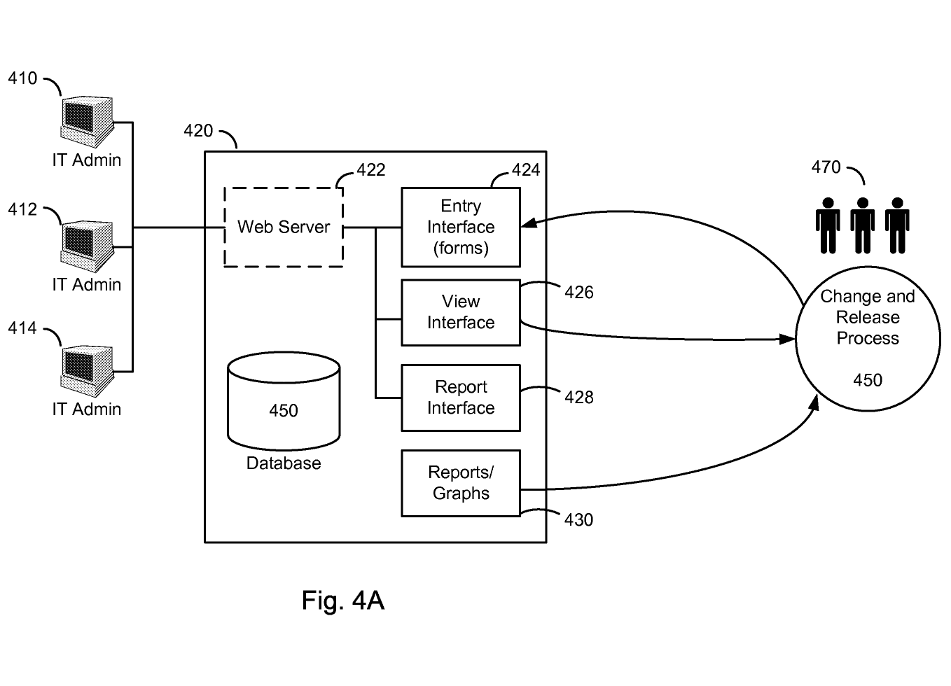

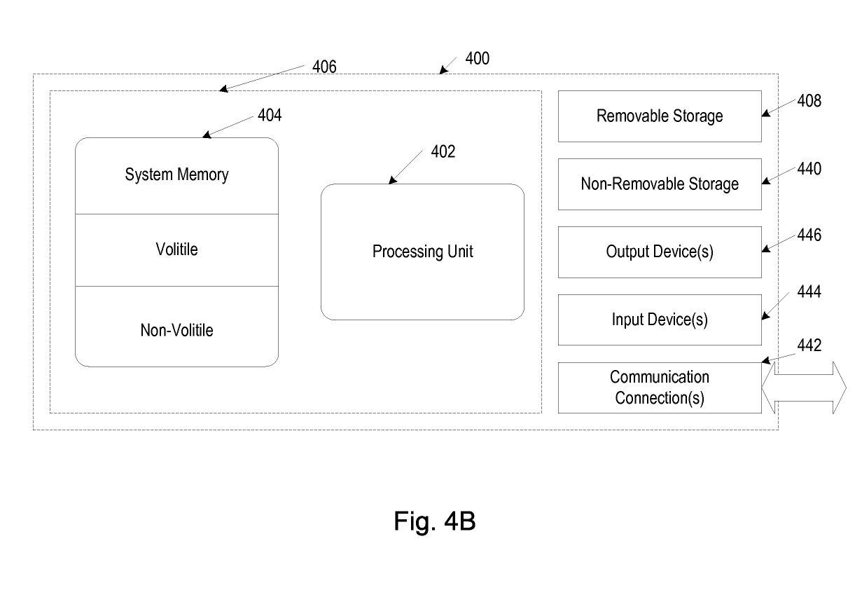

FIGS. 4A and 4B illustrate a system for implementing the method disclosed in FIGS. 1, 2 and 3. A computing system 420 may include, for example, data store 450 and application programs which provide an entry interface 424, a view interface 426, a report interface 428, and reports or graphs 430. The interfaces and reports may be provided by computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Data is entered into the data base 450 in the format as defined in Table 1 below. In one embodiment, data base 450 may comprise a Microsoft SharePoint server, but any type of database may be utilized. In accordance with the method of FIGS. 1 through 3, IT administrators 410, 412, 414 interact with the entry interface 424 to enter a set of data defining a change request as discussed at FIG. 2 above. In one embodiment, a web server 422 may be optionally provided to provide the entry interface in a web browser on one or more computing devices of the IT administrators 410, 412, 414. Alternatively, the entry interface may be provided directly to the administrators by a dedicated processing application. It will be further understood that each administrator 410, 412, 414 may be operating on a separate computer or on computing device 420.

It should be recognized that one or more of devices 400 may also make up an IT environment, and multiple configurations of devices may exist within the organization. This can be grouped and tracked in the organization and various organizations may have different configurations. Each configuration and the manner of tracking it is customizable.

Once data is entered into the entry interface as discussed above with respect to FIG. 2, the view interface 426 selectable by the administrators provides a means to view the change request as discussed above with respect to step 140. Various examples of view interfaces are illustrated below. One or more views in the view interface may be reviewed by a change and release management committee 470 in accordance with the change and release process 450. When a change record is updated with release information, this information may be provided in accordance with step 170. The report interface 428 allows the IT administrators to generate reports and graphs based on the data provided in the change and release entry interface 424. Examples of information culled from the report interface is listed below.

As will be noted from the foregoing discussion, there is little distinction from the data perspective between a change and a release. That is, a changed item is treated as a release item and all elements in the data structure recorded relative to the change can then be utilized to record the release.

Each computing system in FIG. 4A may comprise a system such as that illustrated in FIG. 4B. With reference to FIG. 4B, an exemplary system for implementing the invention includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 4B by dashed line 406. Additionally, device 400 may also have additional features/functionality. For example, device 400 may also include additional storage (removable and/or non-removable) including, but not limited to, magnetic or optical disks or tape. Such additional storage is illustrated in FIG. 4B by removable storage 408 and non-removable storage 440. Computer storage media includes volatile and nonvolatile, removable and non-removable media implemented in any method or technology for storage of information such as computer readable instructions, data structures, program modules or other data. Memory 404, removable storage 408 and non-removable storage 440 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400.

Device 400 may also contain communications connection(s) 442 that allow the device to communicate with other devices. Communications connection(s) 442 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 400 may also have input device(s) 444 such as keyboard, mouse, pen, voice input device, touch input device, etc. Output device(s) 446 such as a display, speakers, printer, etc. may also be included. All these devices are well know in the art and need not be discussed at length here.

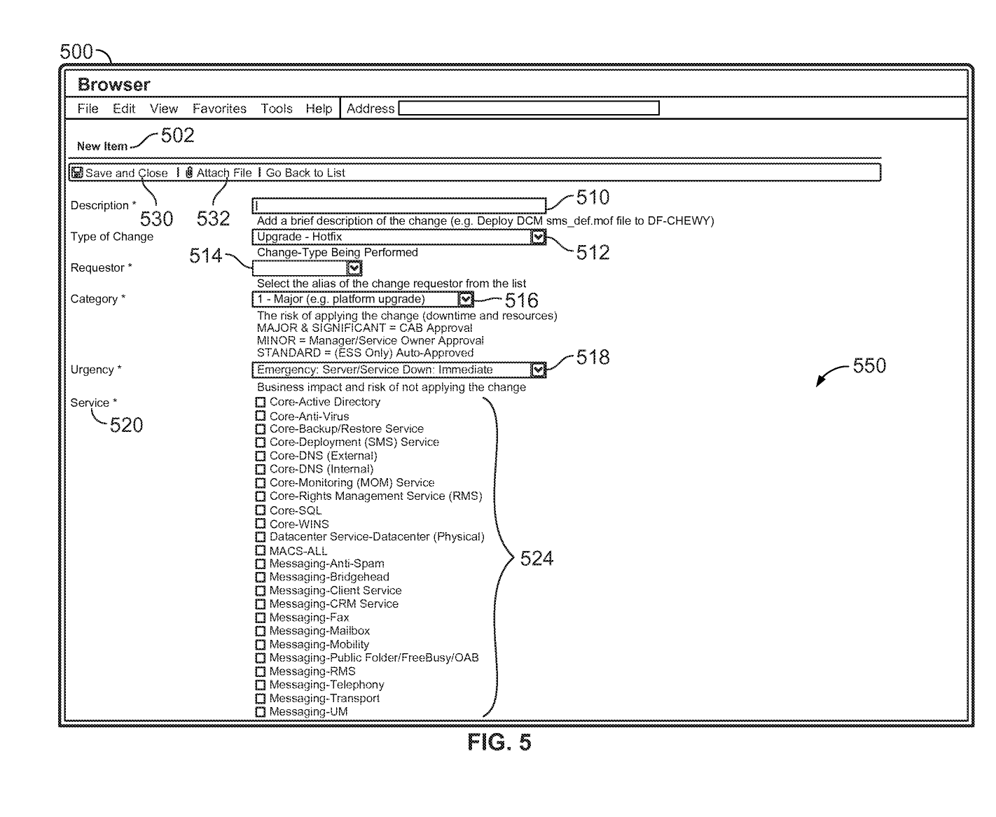

FIG. 5 illustrates one embodiment of an entry interface 424 provided in a window 500. In the embodiments shown in FIG. 5, window 500 is a web browser window which may be provided by web server 422 and rendered using any number of web-based programming languages. The entry interface 550 includes a plurality of data entry fields allowing an IT administrator to input data into the schema defined herein for a change and release record. As illustrated therein, interface 550 is an interface for a new item 502, but other interfaces may be provided to access data in the schema. Once data is entered into the form fields of interface 550, clicking the save and close radio button 530 will result in the data being stored in database 450. The data fields shown in FIG. 5 represent a subset of those in the schema list of Table 1, below. These include: an item description 510, which may be a brief description of the change; the type of change 512; the identity of the requestor 514; the category of change 516; the urgency of the change 518; and the group (in this case a service) 520 to which the change applies. In this embodiment, a number of potential groups (services) are identified by radio check boxes 524, allowing the user to check off one or more checkboxes 524 in the interface. It will be understood that interface 502 may provide entry for any number of data items.

Table 1 lists schema used with the technology described herein for identifying each change and release entered in the database 450. Table 1 includes any number of data items which are not shown in interface 502. However it will be understood that interface 502 may display all or subset of the data items. In one embodiment, a subset of data items is required to complete the entry of a change request into system 420.

Table 1 lists each of the elements in the schema, a description of the element, a type of element data which is recorded, and any given options for the data item. Many of the elements in the table are self-explanatory. It should be recognized that the fields listed in Table 1 are exemplary and in various embodiments, not all fields may be used or additional fields may be used.

TABLE 1

| Field | Description | Type | Options/Entries |
|---|---|---|---|
| Unique Identifier | Unique ID | Number- | n/a |
| | (primary key) | auto- | |
| | | generated | |
| Description | Brief description | Text-255 | n/a |
| | of the change or | characters | |
| | release | | |
| Type of Change | Select the type of | Drop-down | Upgrade - Hotfix |
| | change from the | list | Upgrade - Packaged |
| | list | | Release |
| | | | Upgrade - Service Pack |
| | | | Config Change (e.g. |
| | | | Registry change, |
| | | | Boot.ini switch) |
| | | | Hardware - New Server |
| | | | Hardware - Decomm |
| | | | Server |
| | | | Maintenance - H/W |
| | | | (Replacement, Failure, |
| | | | etc . . . ) |
| | | | Maintenance - S/W |
| | | | (Defrag, etc . . . - No |
| | | | actual changes made) |
| Requestor | Select the | Drop-down | Each possible |
| | requestor's name | list | requestor's name in |
| | from the list | | alphabetical order |
| Category | The risk and/or | Drop-down | 1-Major (e.g. platform |
| | cost of applying | list | upgrade) |
| | the change (‘how | | 2-Significant (e.g. |
| | big is the change, | | service pack upgrade) |
| | what is the | | 3-Minor (e.g. server |
| | resource cost?’) | | configuration change) |
| | | | 4-Standard (pre- |
| | | | approved) |
| Urgency | The risk and/or | Drop-down | Emergency: |
| | cost of not | list | Server/Service Down: |
| | applying the | | Immediate |
| | change (‘how | | High: Imminent Failure: |
| | urgent is the | | <24 hours |
| | change?’) | | Medium: |
| | | | (optional . . . discouraged) |
| | | | Low: can wait until next |
| | | | monthly release: >7 |
| | | | days |
| Service | The service(s) | Multi-select | All of the services and |
| | that the change | list | setting groupings from |
| | applies to | | the service map(s) |
| Stream | The applications, | Drop-down | All of the application, |
| | hardware models, | list | hardware, and setting |
| | or groupings of | | streams from the group |
| | settings being | | or service map(s) |
| | changed | | |
| Forest(s)-Domain(s) | Which forest(s) | Multi-select | Forest(s)-Domain(s) |
| | and domain(s) | list | from the service map(s) |
| | will the change | | |
| | be applied to? | | |
| Service Owner | Has the service | Multi-select | List of all service |
| Approved? | owner(s) for the | list | owners from service |
| | service(s) that the | | map |
| | change applies to | | |
| | approved the | | |
| | change? | | |
| Instructions/Comments | Why does the | Lines of | n/a |
| | change need to | text-10 | |
| | be made? What | lines (could | |
| | problems does it | link to | |
| | address, etc | outside | |
| | | document) | |
| Deployment Plan | What is the | Lines of | n/a |
| | deployment | text-20 | |
| | schedule/plan? | lines (could | |
| | | link to | |
| | | outside | |
| | | document) | |
| Dependencies on | Are there | Lines of | n/a |
| other | dependencies on | text-5 lines | |
| Changes/Releases | other changes? | (could link to | |
| | | outside | |
| | | document or | |
| | | even other | |
| | | records | |
| | | within the | |
| | | same DB) | |
| Rollback plan | What is the | Lines of | n/a |
| | rollback/mitigation | text-20 | |
| | plan? | lines (could | |
| | | link to | |
| | | outside | |
| | | document) | |
| Contact info | Phone, email, etc | Lines of | n/a |
| | for requestor and | text-5 lines | |
| | other relevant | (could link to | |
| | resources | outside | |
| | | document) | |
| Date Change Request | Date Change | Date Field | n/a |
| Entered | Request Entered | (preferably | |
| | | automatically | |
| | | generated) | |
| Target Start Date/Time | When is the | Date and | n/a |
| | change planned | Time Field | |
| | to begin | | |
| Target End Date/Time | When is the | Date and | n/a |
| | change planned | Time Field | |
| | to be complete | | |
| Expected SERVER | How many server | Number | n/a |
| Downtime Minutes | downtime | | |
| | minutes (how | | |
| | long will the | | |
| | physical server | | |
| | be down?) | | |
| Expected SERVICE | How many | Number | n/a |
| Downtime Minutes | service downtime | | |
| | minutes (how | | |
| | long will the | | |
| | service be | | |
| | down? . . . Take a | | |
| | cluster as an | | |
| | example. A | | |
| | single node may | | |
| | go down for 1 | | |
| | hour, but failover | | |
| | gets the service | | |
| | back up in 5 | | |
| | minutes) | | |
| Expected DATABASE | If a DB | Number | n/a |
| Downtime Minutes | server/service will | | |
| | be impacted, how | | |
| | many DBs? | | |
| | Formula: # DBs | | |
| | * service | | |
| | downtime | | |
| | minutes | | |
| DCM Change Needed | Does the RFC | Yes/No | n/a |
| | necessitate a | | |
| | need for a new or | | |
| | edited DCM | | |
| | (Desired | | |
| | Configuration | | |
| | Monitoring) | | |
| | template change | | |
| If approved, approved | Who approved | Drop-down | 1 & 2-Senior Manager |
| by? | the change? | List | (Significant or Major |
| | | | AND Low or Medium) |
| | | | 1 & 2-Senior Manager |
| | | | (Significant or Major |
| | | | AND High or |
| | | | Emergency) |
| | | | 3- Change Manager |
| | | | (Minor) |
| | | | 4-Auto-Approved |
| | | | (Standard) |
| Status | Which stage of | Drop-down | 1-Requested |
| | the | List | 2-Approved Initially (i.e. |
| | process/workflow | | in Plan/Build/Stabilize) |
| | is the change in? | | 3-Approved for |
| | | | Deployment (i.e. in |
| | | | progress) |
| | | | 4-Post Implementation |
| | | | Review |
| | | | 5-Complete |
| | | | 999a-Rejected |
| | | | 999b-Closed due to |
| | | | RFC change |
| ChangeID | Link to another | text-255 | n/a |
| | change control | characters | |
| | system if relevant | | |
| Assigned To | Who owns/is | Drop-down | Populated with all |
| | accountable for | List | possible owners |
| | the change? | | |
| If rejected, by whom | If the change was | Drop-down | 1 & 2-Senior Manager |
| and what criteria? | rejected, who | List | (Significant and Low) |
| | rejected it? | | 1 & 2-Senior Manger |
| | | | (Significant and |
| | | | Medium) |
| | | | 3-Change Manager |
| | | | (Minor) |
| If Rejected, Reason | If the change was | Lines of | n/a |
| for Rejection | rejected, why was | text-5 lines | |
| | it rejected? | | |
| Actual Implementation | When was the | Date and | n/a |
| Date/Time | change/release | Time Field | |
| | actually | | |
| | implemented? | | |
| Implemented By | Who | Drop-down | All possible |
| | implemented the | list | implementers |
| | change/release | | |
| Implementer | Optional | Lines of | n/a |
| Comments | comments about | text-5 lines | |
| | implementation | | |
| Actual SERVER | How many server | Number | n/a |
| Downtime Minutes | downtime | | |
| | minutes (how | | |
| | long will the | | |
| | physical server | | |
| | be down?) | | |
| Actual SERVICE | How many | Number | n/a |
| Downtime Minutes | service downtime | | |
| | minutes (how | | |
| | long will the | | |
| | service be | | |
| | down?) | | |
| Actual DATABASE | If a DB | Number | n/a |
| Downtime Minutes | server/service will | | |
| | be impacted, how | | |
| | many DBs? Take | | |
| | # DBs * service | | |
| | downtime | | |
| | minutes | | |
| Servers Changed | Which physical | List | n/a |
| | servers were | | |
| | changed? | | |
| # Servers Changed | How many | Number | n/a |
| | servers were | | |
| | changed? | | |
| Post Implementation | Action items | Test, or | n/a |
| Review Action Items | created b/c of this | preferably | |
| | change. | link to | |
| | | records in an | |
| | | action item | |
| | | table | |
| Close Date | Date/Time record | Date/Time | n/a |
| | is closed. | | |

While many of the fields are self explanatory, further discussion of other fields follows.

The unique identifier field associates the unique identifier with each change request entry. The unique identifier may be auto generated upon entry of an item into the user interface.

The description item allows users to enter descriptive text regarding a brief description of the change or release.

The “type of change” category allows user to select a type of change from a drop down list. Examples of the type of changes are shown in Table 1 and can include “upgrade/hot fix”, “upgrade-package release” and the like. It will be understood that each of the options listed under type of change may be customized for a particular IT organization and the labels shown under the options heading are merely exemplary. Likewise, the “category” field may be used to track the risk or cost of applying the change and may include categorizations such as “major” “significant” “minor” and “standard”. Again, each of these options may be customized for a particular IT organization.

The “service” field is an example of one group of common elements that at a change may be applied to. Hence, “services” are one group which may be defined in accordance with step 110 for a particular IT organization. In other embodiments of the technology, groups may include services, “streams” or hardware categories, and a “forest” or “domain” category. The “stream” group may include applications, hardware models, or groupings of settings being changed. The “domain” may include a group of clients and servers under the control of one security database. As indicated in Table 1, each of the three elements may be identified by field in the schema for tracking change and release elements. In various embodiments, one, two or all three of the service/stream/domain groups may be entered to define the relationship of any change and release record.

The “service owner approved” field can track, relative to a particular service, whether the owner of the service has approved the change. The service owner is a role typically assigned to an individual who is accountable for a service.

The “expected server downtime minutes,” “expected service downtime minutes” and “expected database downtime minutes” fields track three separate elements of the affect of a change or release on an IT infrastructure. Because each of these three items may be different, the schema allows a report to be generated to illustrate the true affect of a change or release on each of these separate data points. To illustrate the difference between server, service and database downtime, consider a case of a single mailbox server machine running, for example, Microsoft Exchange 2003, and having five databases. If the physical server is down for three hours, this would constitute three hours of server downtime, three hours of email service downtime, and fifteen hours (three hours multiplied by five databases) of database downtime. Consider further that the mailbox server is paired with another mailbox server in a two node, fail over embodiment. If one of the two servers fails for three hours, and five minutes are required for the second server to take over, this would constitute three hours of server downtime, five minutes of fail over downtime (service downtime), and twenty-five minutes of database downtime (five minutes times five databases). Note that other metrics may be utilized. For example, another metric could be ‘user impact’ which is tracked in amounts of user downtime minutes.

An advantage of the present technology is that each of these elements may be tracked separately and reported to the IT managers. Each metric measures a different effect on the business and end users of the services, as well as how well the IT organization is performing.

The “approved by” field allows tracking of who approved the change and allows for auto approved, change manager, supervisor, and IT manager categories. Each of the types of managers who may approve a change may be customized within a given IT organization.

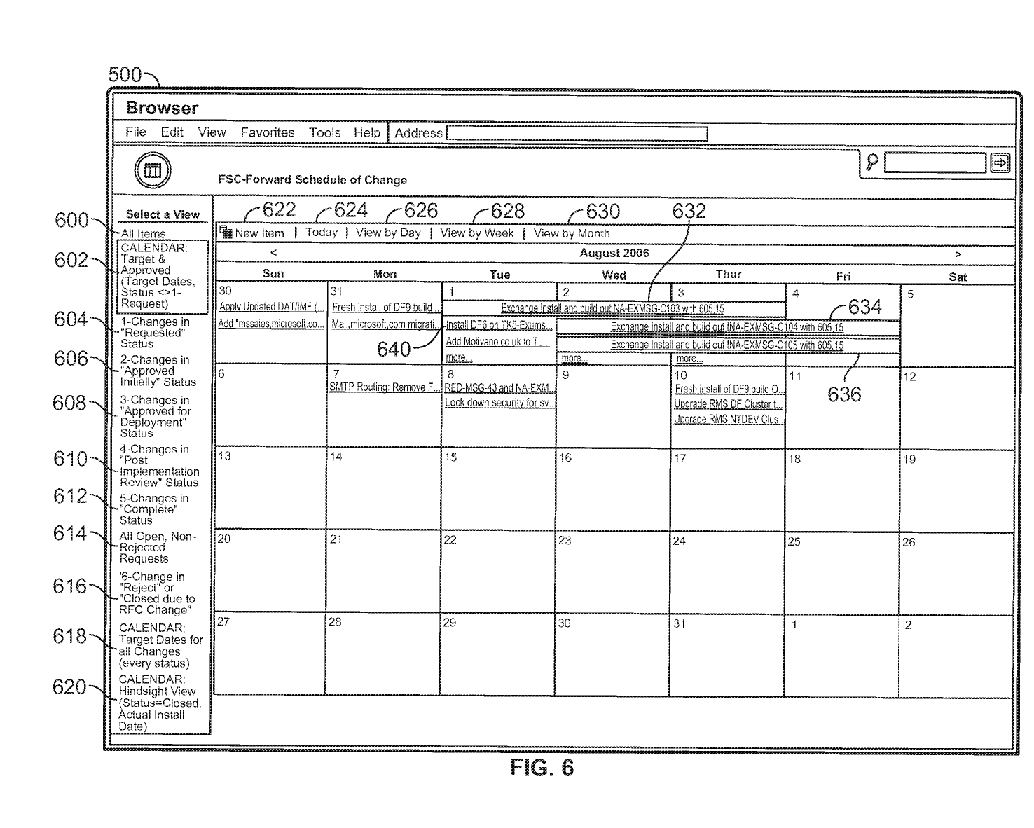

The “status” field tracks the status of the change request but also drives views illustrated in FIGS. 6 through 8. As explained further below with respect to Table 2, the views provided by the technology may be ordered to drive a change management process, allowing change managers to cycle through the views in an orderly manner to review changes and releases at various stages of the management process. Note that the status attribute is used in the view table criteria, in Table 2 below.

The “rejected by” field is similar to the “approved by” field for changes which are rejected in the change management process.

The “actual implementation date/time” field may be entered manually or determined automatically by linking dynamic outage data back to the change record. Likewise, the actual server, service, and database downtime fields record the actual server service and downtime elements. Each of these fields may be manually entered or automatically calculated by summing downtime with dynamically generated outage records which are linked back to the change release request.

The “service change” field tracks which physical servers were changed and may be a manually entered field or automatically filled from links from an outage table stored in database 450. Likewise, the “number of servers changed” may be manually entered or automatically generated from an outage table. The “posted implementation review action items” may be a text entry field of action items for review, or may be a link to records in an action items table. The “close date” is the date that the change management process has approved closing the release record.

As illustrated from the foregoing table, a single record format is utilized for a change and release. This allows all information about a change to be tracked within a common schema and the management review process has instant access to all information about the change plan, the expected effects, and the actual effects of a given change.

As noted above, in one embodiment, certain fields are required to be entered before a change request will be entered. In one embodiment, the required fields include a description, requestor, category, urgency, service, stream, forest-domain, ESS service owner approved, roll back plan, contact info, date change request entered, target start date and time, target end date/time, expected server downtime minutes, expected service downtime minutes and expected database downtime minutes. Before closing a completed release, the actual server, service and downtime minutes fields may be required.

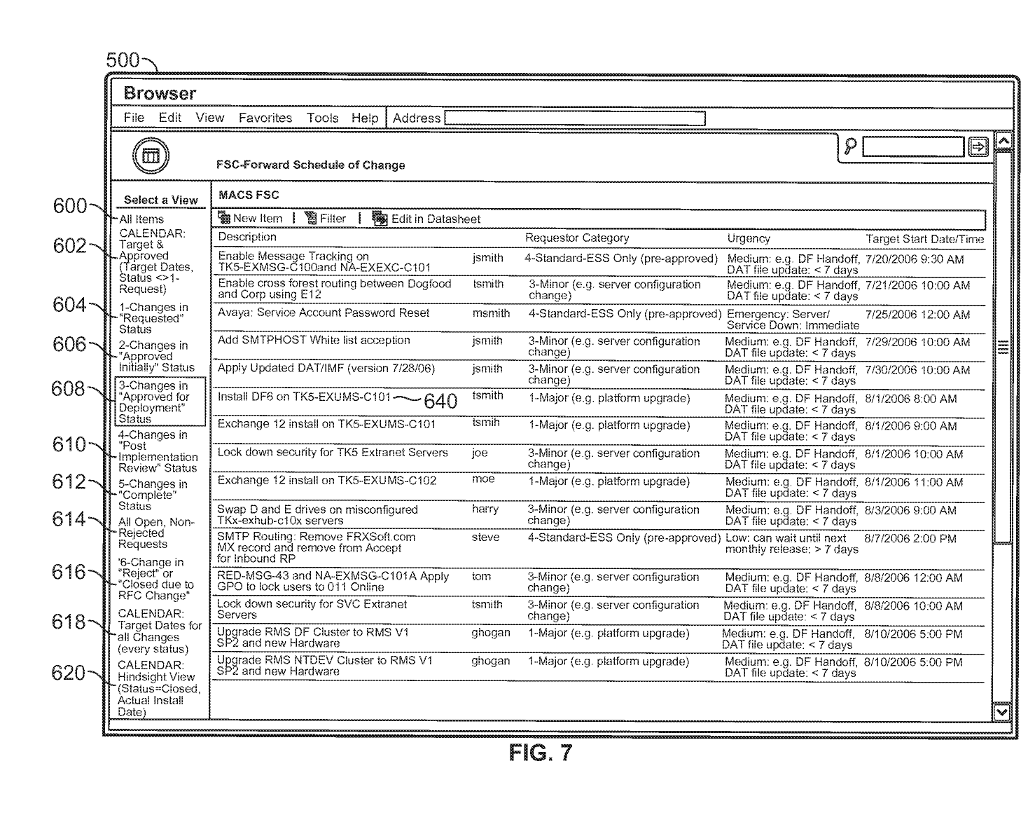

Table 2 lists the types of views provided by the view interface. FIGS. 6 and 7 illustrate two of the views described in Table 2. Table 2 provides a brief description of each of the views and their “status”. In one embodiment, the status is a reflection of an ordering of the views in a change and management process: Note that the status in the criteria field matches the status attribute in Table 1, above.

TABLE 2

| View Name | Description | Criteria |
|---|---|---|
| All Items | All records grouped by status with count for each | All records |
| | status grouping | |
| CALENDAR: Target | Calendar view for all changes that have been | Status < > 1- |
| & Approved (Target | approved shown by their target dates | Request |
| Dates, Status < > 1- | | |
| Request) | | |
| 1-Changes in | List view for all changes that are in requested | Status = 1* |
| “Requested” Status | status | |
| 2-Changes in | List view for all changes that have been | Status = 2* |
| “Approved Initially” | approved initially, but aren't ready for final | |
| Status | approval before deployment (i.e. they are being | |
| | planned, built, tested, etc) | |
| 3-Changes in | List view for all changes that have been | Status = 3* |
| “Approved for | approved for deployment, (i.e. they are ready to | |
| Deployment” Status | be deployed, but deployment is not complete) | |
| 4-Changes in “Post | List view for all changes that have been | Status = 4* |
| Implementation | completely deployed, but have not yet completed | |
| Review” Status | the post implementation review step (if | |
| | needed . . . all significant and major changes, and | |
| | any standard or minor changes that failed) | |
| 5-Changes in | List view for all changes that have completed all | Status = 5* |
| “Complete” Status | steps, including Post Implementation Review. | |
| All Open, Non- | List view of all changes that aren't closed or | Status = 1* or |
| Rejected Requests | rejected | 2* or 3* or 4* |
| ‘6-Change in “Reject” | List view of all rejected changes | Status = 999* |
| or “Closed due to | | |
| RFC Change” | | |
| CALENDAR: Target | Calendar view for all changes by their target | All changes |
| Dates for all | dates | |
| Changes (every | | |
| status) | | |
| CALENDAR: | Calendar view for all changes that have been | Status = 5* |
| Hindsight View | closed shown by their actual install dates | |
| (Status = Closed, | | |
| Actual Install Date) | | |
| CLOSED Today | View of all changes closed today | Status = 5* |
| | | and close |
| | | date = [today] |

Different types of views, including calendar and list views, may be provided. FIG. 6 illustrates a calendar view shown in window 500. The view 602 entitled “CALENDAR: Target & Approved” is selected and shown. In this view, a calendar month is displayed with any number of change request items such as items 632, 634, 636 and 640 shown relative to their target installation date as entered in the projected start and finish fields. It will be understood that each of the items in the calendar view shown in FIG. 6 including items 632, 634 and 636 may comprise a hyperlink which, when selected, return to record similar to that shown in FIG. 5, providing a detailed view of the change or release.

As illustrated in FIG. 6, each view may be provided in a browser window 500. Each view is selected from a linked list of views 600, 602, 604, 606, 608, 610, 612, 614, 616, 618, 620. Alternative mechanisms for selecting views may be utilized as will be recognized by one of average skill in the art. For example, where the database is provided in an SQL database, SQL queries or SQL Reporting Services may be used to generate views.

FIG. 7 illustrates a list view 608 in window 500 entitled “Changes In ‘Post Implementation Review’ Status”. This view lists all items in a give status by description, requestor, category, urgency and target start date/time. As shown therein, item 640 “install DF6 on TK5” is scheduled for deployment on Aug. 1, 2006 as illustrated in both the calendar view and the listing view shown in FIG. 7.

The All Items view 600 lists all records generated by status with account for each status grouping. The “Calendar Target & Approved” view 602 is a calendar view for all changes that have been approved shown by their target dates.

To implement best practices such as those defined by ITIL requires regular meetings. The service views can be used to drive a change and advisory board meeting. In this case, the status lists can comprise agenda items for the change advisory board meeting. Users can simply change from view to view to view the order of the agenda as the times change in the review meeting.

Views 604, 606, 608, 610, 612 all include a status identifier which allows the technology to drive the change and release management process. In this example, changes may go from “requested” status to “approved initially” status, then to “approved for deployment” status, “post-implementation review” status, and “complete” status. View 604 indicates a status “1” (the first step in a change and release management process) which lists all changes that are requested and are in requested status. A change and review committee or IT manager can utilize this view to review all changes that are in requested status. Similarly, view 606 lists all changes which have been approved initially but are not ready for final approval before final appointment. This situation may cover changes which are being planned, tested and built or are otherwise not ready for actual deployment to the IT enterprise. View 608, status “3”, lists all changes that have been approved for deployment. These are changes which are ready to be deployed but for which deployment is not complete. View 610 status “4” is a list view for all changes that have been completely deployed but have not yet been completed through the post-implementation review step. It will be understood that this post-implementation review is generally required in significant and major changes and any standard or minor changes that failed as identified by the category of the change as described above. View 612 “changes in ‘complete’ status” is a list before all changes have completed all steps, including a post implementation review. View 614 is an all open non-rejected request view which lists all changes that are not closed or rejected. View 616 is a list view of all rejected changes. Additional views 618 and 620 provide a calendar view for all changes by their target date and the calendar view for all changes that have been closed shown by their actual install dates. A “closed today” view lists all changes which are closed on a particular date. It will be understood that any number of additional views may be provided by linking each of the items in a particular field back to that in the data structure.

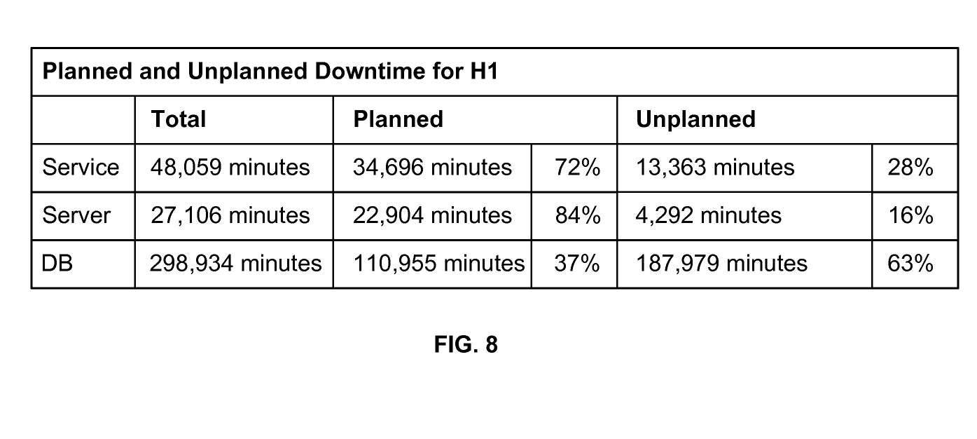

FIGS. 8 through 19 illustrate the graphs and reports which are capable of being generated by the report generator 430. Any one or more of these tables and graphs may be generated via the report interface 428 into a report 430 for use in a change and release management process of the organization.

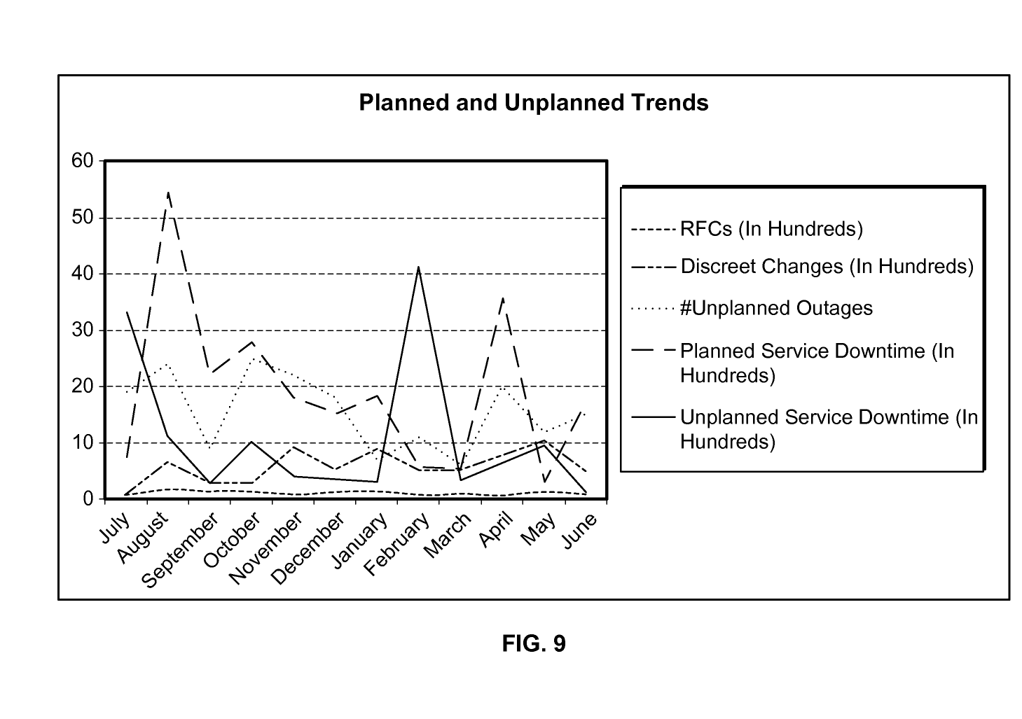

FIG. 8 shows a table of the planned and unplanned downtime for a particular service “H1” for a given period of time. FIG. 9 is a graph illustrating the planned and unplanned trends relative to the request for changes, discrete changes, the number of unplanned outages, and the planned and unplanned service downtime in hundreds of hours. Planned vs. unplanned trends allow one to strive for all downtime to be planned. The ratio of planned to unplanned downtime is an indicator of how well an IT organization is meeting the needs of the organization. The graph culls data from the change records as well as data on actual downtime which may be available to the IT organization in incident or problem records.

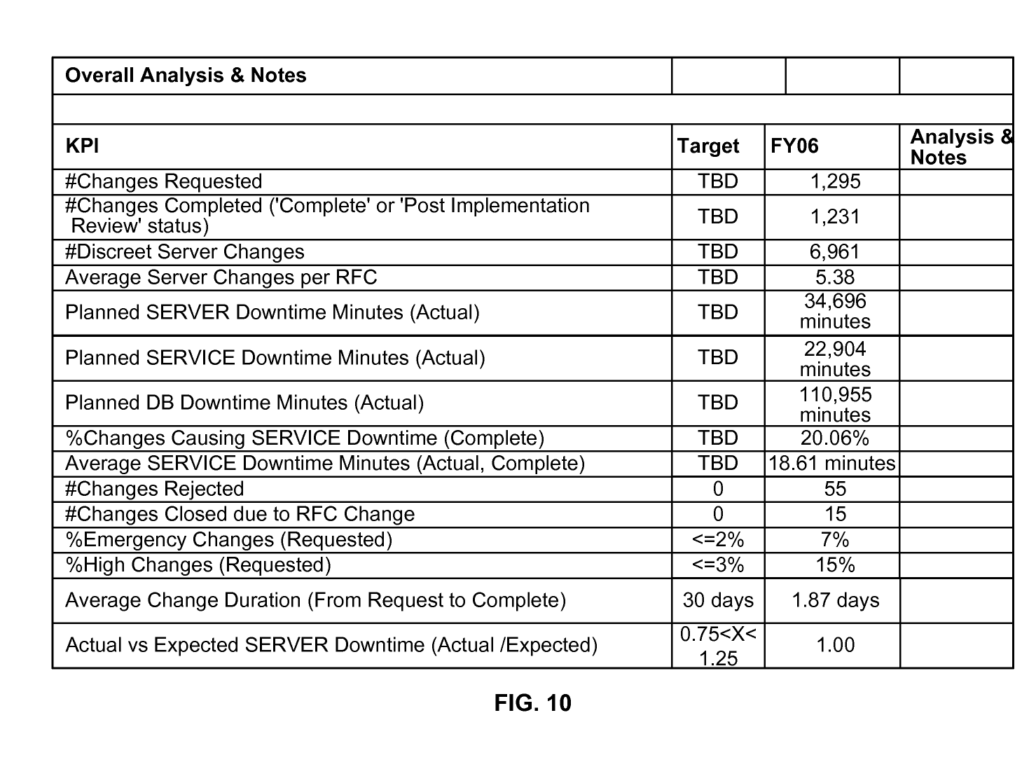

FIG. 10 is a table illustrating the types of reporting information which can be called from the database. The table lists a description of the item, a target goal, an actual result and allows for analysis text to be inserted.

With reference to FIG. 10, the “number of changes requested” metric is a count of the number of request for change in a given period. Using the present technology of release management, by designating change requests to a group, fewer change requests will be logged since in effect, a single release is be logged for multiple changes across group elements. This allows one request for the same change on multiple servers to be logged. The “target” of this metric is a norm which should be determined and subsequently be set by the IT organization. Under the heading FY06, a total of 1,295 changes or release requests were logged during the fiscal year 2006.

The “number of changes completed” is a metric indicating the number of change requests completed in the period that are in “complete” or “post-implementation review” status. A target should be determined and subsequently set.

The “number of discrete server changes” indicates the number of discrete server changes for the given period. This number should be greater than the number of changes and releases requested and, in the example shown in FIG. 10 is substantially greater at 6,961.

The “average server changes per RFC” is the number of discrete changes for each request for change. This ratio will increase as the technology is implemented and given IT organization.

The “planned server . . . ,”, “planned service . . . ,” and “planned database downtime in minutes” are the actual number of minutes for each of the three categorical groups discussed above. Server downtime is a good measure of downtime that the IT organization managers must deal with. Service downtime is a good measure of a customer or business unit's experience with downtime. Database downtime is a good measure of a user's experience with downtime. This is especially true in an email server environment where each database in the environment hosts a similar number of users. For other back-end, database driven services, a comparable measurement would be user downtime minutes which is equal to the number of concurrent or active users multiplied by the service downtime minutes.

The “percentage of RFCs causing service downtime” indicates what percentage of change requests constitutes service downtime. This metric is a good indication of an IT group's frequency of business impact with planned downtime. IT groups should look for ways to reduce business impact.

The “average service downtime minutes” is an average of the service downtime minutes per request for change and gives a good indication of the impact the IT department is having on the business with changes.

The “number of RFCs rejected” is a metric of the change requests rejected in a given period. Rejected changes are indicative of changes being requested that should not be requested or that have been miscoded. Either type of change puts undue load on the change and release management processes and wastes company resources.

The “number of RFCs closed due to RFC change” indicates the number of change requests which were changed materially after requested. If a change request was changed materially after it is requested, it should be closed. This is indicative of a poorly planned request or some other unwanted situation.

The “percentage of emergency discrete changes” indicates the percentage of discrete changes that were requested with emergency urgency during the period. Emergency changes by definition are reactive introduced risk into a business. The average change to duration indicates the average duration from change request to change completion. This metric is a good indicator of the proactive nature of the change and release management process.

The “actual versus expected server downtime” is a metric indicating the predictability of the change and release managing processes. Ideally too much downtime will not be predicted and likewise too little downtime will not be predicted. Predictability should be, in one embodiment, within 0.25% and improve over time.

The “actual versus expected server downtime” calculates for each change request in the period where status is complete or post implementation review, a formula as follows: actual server downtime/expected server downtime. If expected server downtime is zero use (actual server downtime)/1. Then the average output of those calculations for the period is provided.

In addition to the metrics listed in the table of FIG. 10, a report may include one or more of the, graphs shown in FIGS. 11 through 19.

FIG. 11 is a graph of service downtime indicating which change requests had the most impact during a given period. As shown in FIG. 11, defragmentation of a public database has a 4% downtime effect, December security patches 3%, January security patches at 3%, etc.

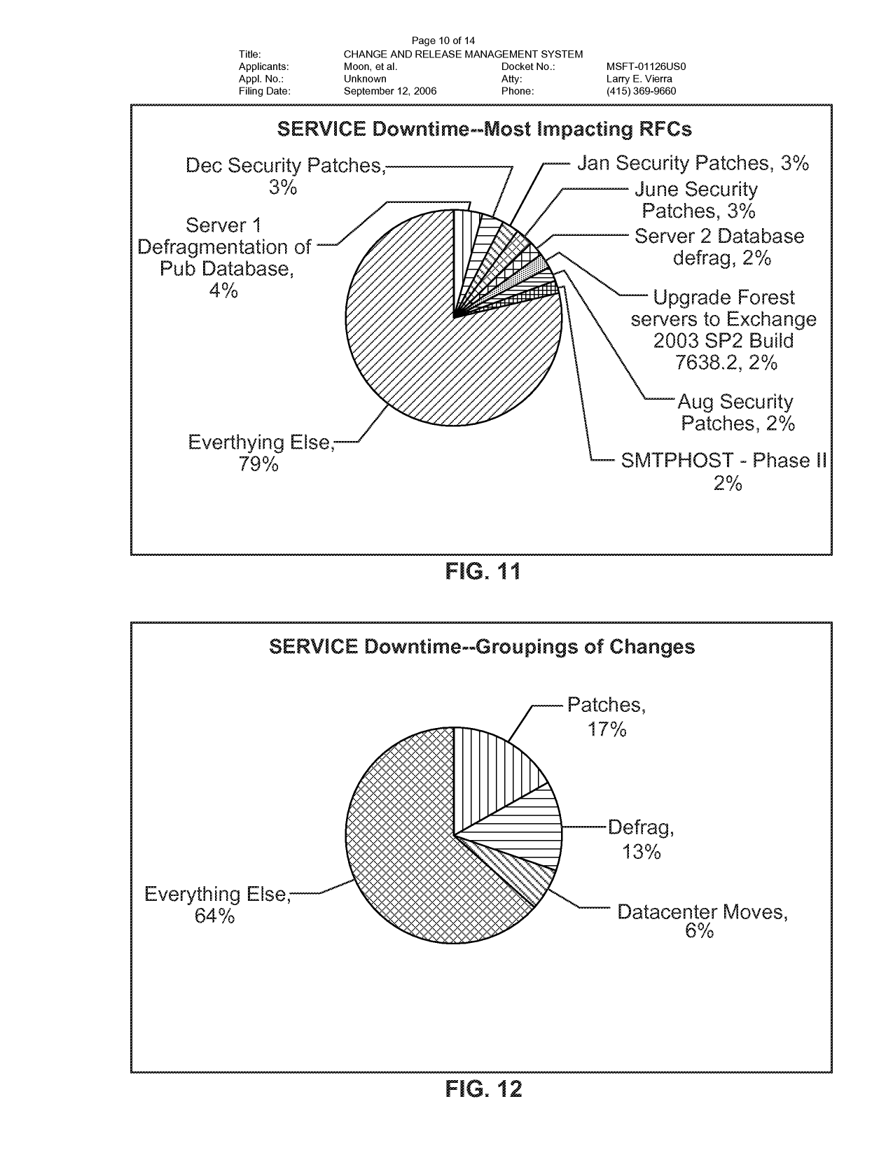

Service downtimes can be grouped by the type of changes and illustrated as shown in FIG. 12. As shown in FIG. 12, patches comprise 17% of service downtimes, defrag 13%, datacenter moves of 6%, and everything else 64%.

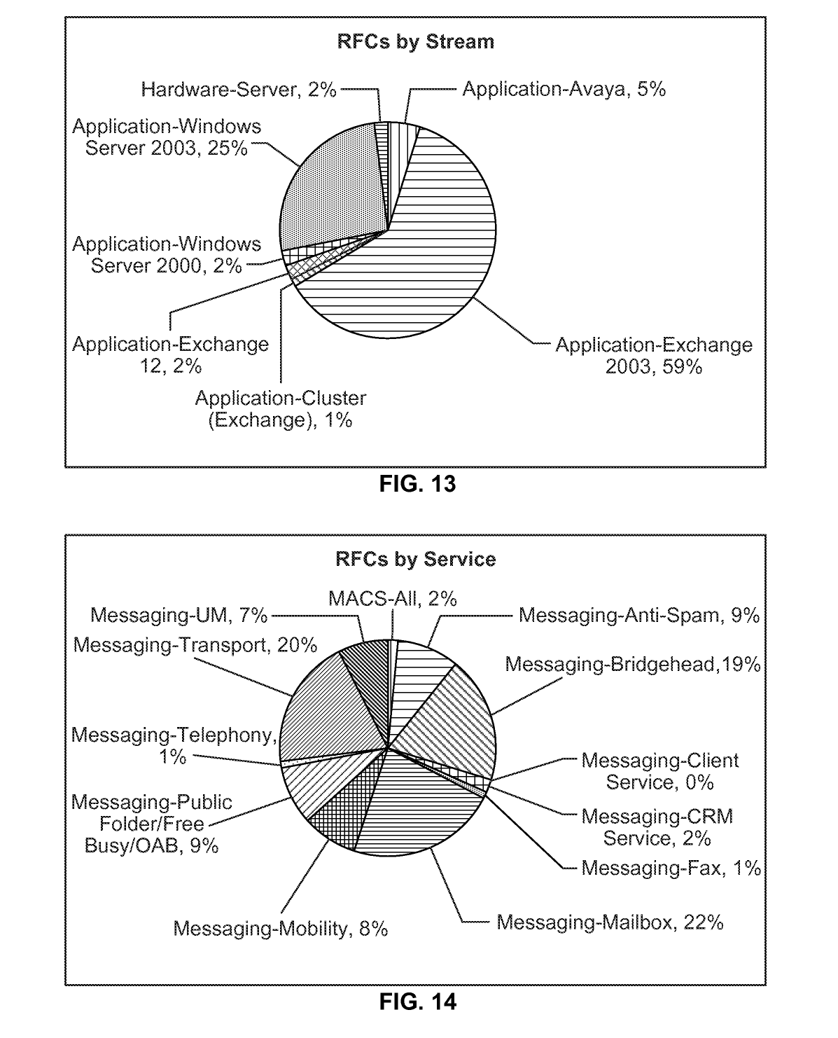

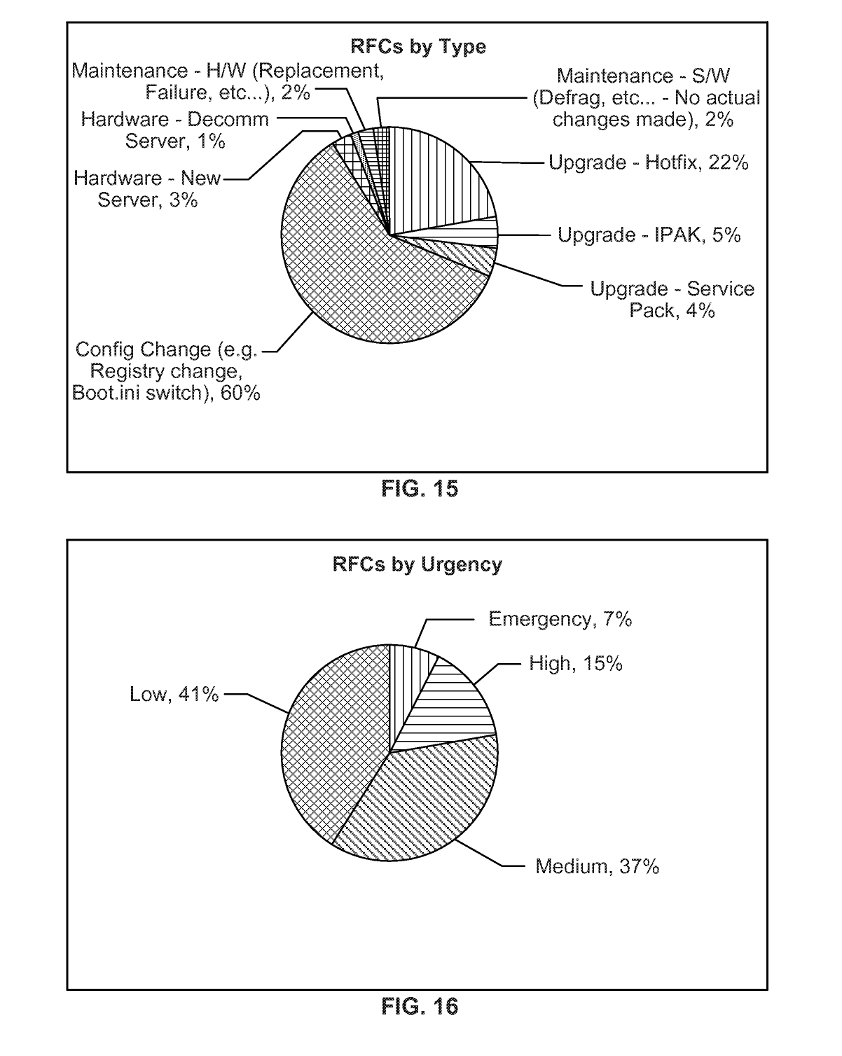

FIGS. 13 through 15 illustrate change requests viewed by stream, service and type respectively. FIG. 13, RFC's by stream illustrates which streams are most frequently changing. Based on the data, an IT manager may want to dive deeper into the Exchange changes to try and drive down the amount of change. FIG. 14, RFCs by service, may be used to determine which services are being changed the most. In this example, transport and bridgehead were the highest changed frequency and one might dive deeper into these particular changes to determine why they were the highest number of changes needed. FIG. 15, RFCs by type, show a distribution of the types of changes the IT department is making. Using this graph, the IT department might take the largest in each time period and attempt to drive changes down for this type of change.

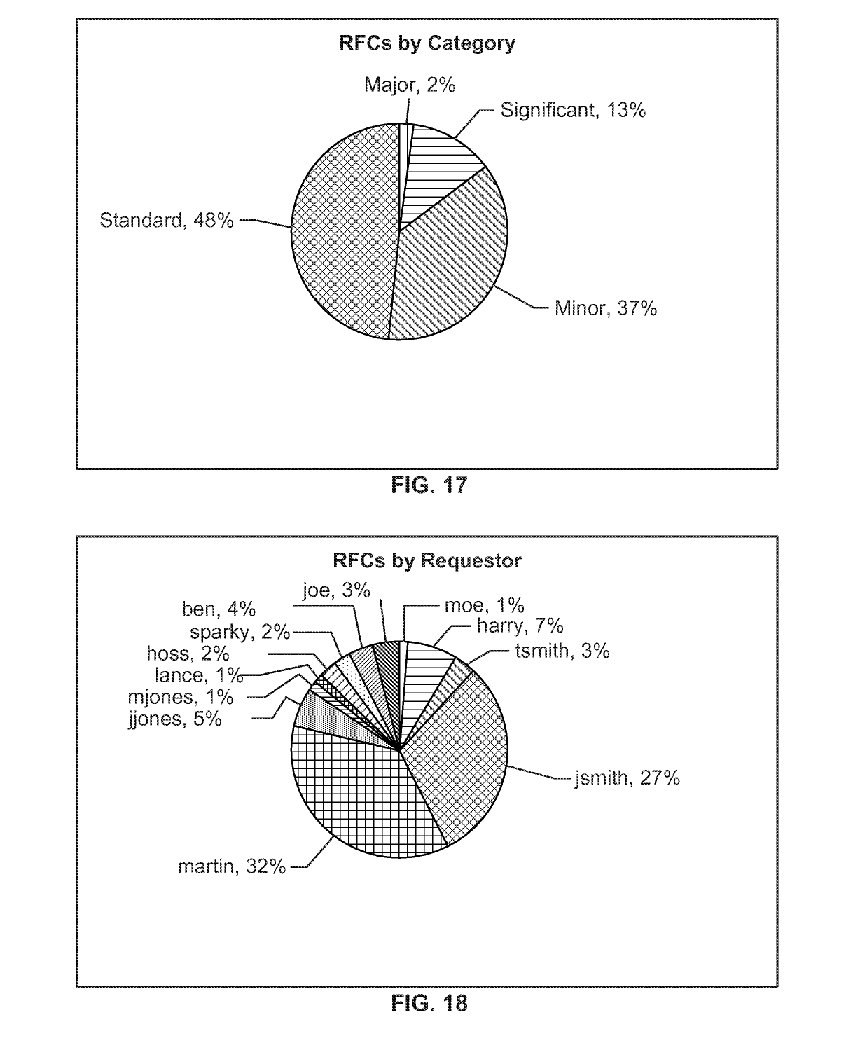

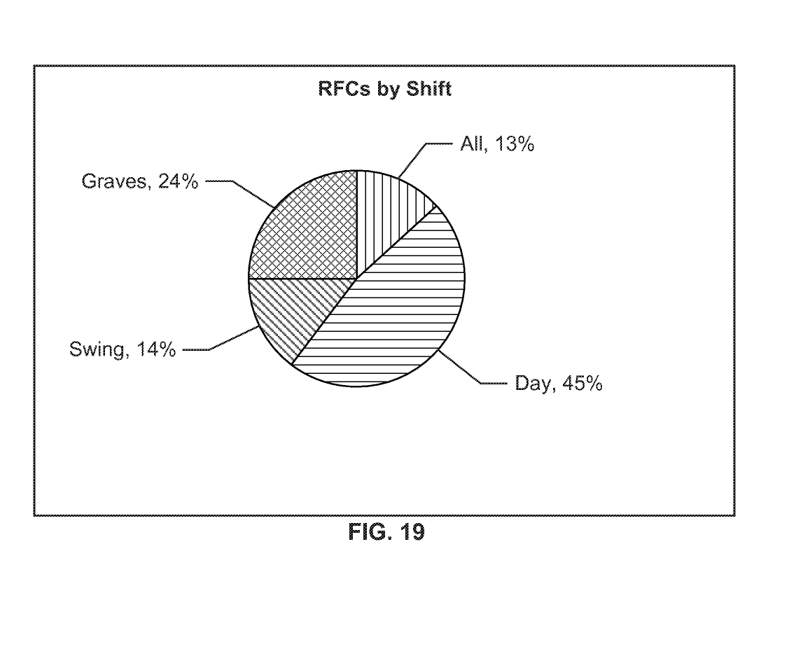

FIG. 16 through 19 illustrate how RFCs can be viewed by urgency, category, requestor, or shift. FIG. 16, RFCs by urgency, allows the IT department to drive toward “low” urgency changes. This is a good indicator that the changes being implemented are of a proactive nature. Another goal might be to drive emergency and hike emergency changes down to 5% or less combined. FIG. 17, RFCs by category, shows the risk and or cost being introduced by the changes. A goal of the IT department would be to limit the number of major and significant changes because they introduce more risk. FIG. 18, RFCs by requestor, helps IT departments understand where changes are coming from. This may indicate a significant number of changes are coming from a particular individual, and may require further investigation with such individual. Similarly, FIG. 19, RFCs by shift, can indicate when changes are being requested.

The present technology therefore provides an advantageous means for conducting a change and release management process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for managing changes to a computing environment, comprising:
organizing the computing environment into a logical representation characterized by groups of elements sharing at least one common characteristic;
recording changes to elements in the computing environment in terms of a change to at least one group of elements; and
storing each change in a common record format including an association of the change with other groups of elements affected by the change.

2. The method of claim 1 wherein the common record format includes at least one of a risk category of the change, an urgency of the change, the services affected by the change, the stream affected by the change, the domain of the change, a target start date, and a target end date.

3. The method of claim 1 wherein the common record format includes at least one of an expected server downtime, an expected service downtime and/or an expected database downtime.

4. The method of claim 3 wherein the common record format includes at least one of an actual server downtime, an actual service downtime and/or an actual database downtime.

5. The method of claim 3 further including the step of reporting on at least one of expected versus actual server downtime, service downtime and/or database downtime.

6. The method of claim 1 wherein the step of recording includes creating a change request by providing a set of required data in the common record format.

7. The method of claim 6 wherein the step of recording further includes adding release data to the common record format for a change request.

8. The method of claim 1 further including the step of outputting one or more views of a collection of change records to a user interface in an order defined by a change management process.

9. The method of claim 1 wherein the collection of views includes at least one of a changes requested view, a changes approved initially view, a changes approved for deployment view, a changes in post implementation review view, a changes complete view and/or a changes rejected view.

10. A method for managing changes to a computing environment, comprising:
providing a common schema for storing a change and release data associated with one or more elements in the computing environment;
recording changes to elements in the computing environment in terms of a change to at least one group of elements; and
outputting one or more views of a collection of changes to a user interface in an order defined by a change management process.

11. The method of claim 10 wherein the common record format includes at least one of a risk category of the change, a type of change, a requester of the change, an urgency of the change, an indicator of services affected by the change, an indicator of a stream affected by the change, an indicator of a domain of the change, a target start date, a target end date, an expected server downtime, an expected service downtime and/or an expected database downtime.

12. The method of claim 11 wherein the common record format includes at least one of an actual server downtime, an actual service downtime and/or an actual database downtime.

13. The method of claim 12 wherein the step of outputting further includes outputting a report detailing at least one of expected versus actual server downtime, service downtime and/or database downtime.

14. The method of claim 1 wherein the step of recording includes creating a change request by providing a set of required data in the common record format.

15. The method of claim 14 wherein the step of outputting includes providing at least one of a changes requested view, a changes approved initially view, a changes approved for deployment view, a changes in post implementation review view, a changes complete view and/or a changes rejected view.

16. The method of claim 15 wherein the step of recording includes updating the change request by following one or more decisions by the change management process.

17. The method of claim 15 wherein the step of recording further includes adding release data to the common record format for a change request.

18. A computer-readable medium having computer-executable instructions for performing steps comprising:
providing an input interface including a common schema for storing change and release data associated with one or more elements in the computing environment;
receiving one or more data records recording changes to elements in the computing environment in terms of a change to at least one group of elements; and
outputting one or more views of a collection of changes to a user interface in an order defined by a change management process.

19. The computer readable medium of claim 18 wherein the step of outputting includes providing at least one of a changes requested view, a changes approved initially view, a changes approved for deployment view, a changes in post implementation review view, a changes complete view and/or a changes rejected view.

20. The computer readable medium of claim 18 wherein the step of receiving includes receiving a change request including a set of required data in the common record format and receiving release data in the common record format for a change request.
